(19) United States
(12) Patent Application Publication
(10) Pub. No.: US 2009/0139463 A1
(43) Pub. Date: Jun. 4, 2009

(54) Vehicle Mounted Pet Restraint

(76) Inventor: Glenn Robert Morrow, Victoria (AU)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/887,311

(22) PCT Filed: Mar. 28, 2006
(86) PCT No.: PCT/AU2006/000409

§ 371 Date: Sep. 26, 2007

(30) Foreign Application Priority Data
Mar. 29, 2005 (AU) 2005901526

(51) Int. Cl. A01K 27/00; B62B 17/00

(52) U.S. Cl. 119/771

(57) ABSTRACT

A pet restraint for restraining a pet to a vehicle. The restraint includes an elongated member having a first portion proximate the vehicle for mounting the elongated member to the vehicle and a second portion distal of the vehicle for engaging a pet. The first portion comprises at least one fastening means adapted to engage the vehicle and the second portion extends away from the vehicle.

### FIELD OF INVENTION

The present invention relates to the field of restraints. In particular the present invention relates to a method and apparatus for restraining an animal, namely, a pet. It will be convenient to hereinafter describe the invention in relation to the use of a restraining mechanism suitable for use with a dog and adapted for use with a bicycle; however it should be appreciated that the present invention is not limited to that use, only.

The present application hereby explicitly incorporates Australian provisional application No. 2005901526. Australian application No. 2005901526 was filed on 29 Mar. 2005.

### BACKGROUND ART

The inventor has identified the following related art. Many dog owners may wish to take their dog for a walk or a run whilst they ride their bicycle. It is usual for local laws to prevent a dog being off their lead in most public places, which requires the owner to hold the dog's lead with one hand whilst riding the bicycle. The dog owner is also faced with trying to steer their bicycle, change gears and brake with the other hand that is not occupied with the dog's lead.

It has been known for dogs to pull sleds, scooters and the like but in all these instances the dog is only used to pull the sled or scooter. Having a dog pull a bicycle is not feasible if the dog is not strong enough to do so.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

### SUMMARY OF INVENTION

An object of the present disclosure is to at least provide a useful alternative to the related art.

A further object of the present invention is to alleviate at least one disadvantage associated with the related art.

The present disclosure provides a pet restraint for restraining a pet to a vehicle comprising:

an elongated member comprising:

a first portion proximate the vehicle for mounting the elongated member to the vehicle wherein said first portion comprises at least one fastening means adapted to engage the vehicle;

a second portion distal of the vehicle for engaging a pet wherein said second portion extends away from the vehicle.

In one embodiment the said second portion extends away from the front of the vehicle in a direction so as to be laterally spaced therefrom.

In example arrangements of the invention encourage a pet connected to the second portion to be spaced towards the front of the vehicle, so as to be visible, and be spaced laterally from the vehicle so as to limit accidental contact therewith. For example, the second portion comprises a lead attachment for attaching the second portion to a pet lead.

Further, in some embodiments the second portion extends away from the front of the vehicle in a manner whereby the second portion is laterally spaced therefrom and is longitudinally in front thereof. These arrangements serve to encourage the pet to be located well in front of the vehicle. Alternatively the second portion extends away from the front of the vehicle in a manner whereby the second portion is laterally spaced therefrom and is substantially longitudinally inline therewith. Arrangements of this type may be easier to maneuver than those arrangements where the second portion is longitudinally in front thereof.

In an example embodiment, the fastening means may comprise one or more of:

a fixed fastening means and;

an adjustable fastening means.

The adjustable fastening means and the fixed fastening means, in combination, may provide for mounting the elongated member to vehicles of varying shape and size. For example, the vehicle may comprise a bicycle. Equally, the vehicle may be a sled or a scooter or, any other vehicle suitable for recreation whether motorised or not and which would be suitable for use in exercising a pet such as a dog.

In one embodiment the second portion comprises a lead attachment for attaching the second portion to a pet lead such as a dog lead.

According to another aspect of the invention there is provided a pet restraint for a vehicle, the restraint comprising: a elongate member providing a first portion and a second portion; the first portion including at least one fastening means adapted to engage the vehicle such that when the first portion is mounted to the vehicle, the second portion extends in a forward direction, relative to the vehicle, and laterally away from the vehicle in a manner such that when a pet is restrained from the second portion, the pet will be encouraged to be spaced towards the of the front vehicle, so as to be visible, and to be spaced laterally from the vehicle so as to limit accidental contact therewith.

In example arrangements of the invention the second portion is sized such that the pulling does not result in the rider losing his or her balance if the dog suddenly pulls longitudinally or laterally with respect to the vehicle. In arrangements where the dog pulls at a right angle to the bicycle (laterally), the rider has advantageous ability to steer in the direction in which the dog is pulling, as the dog's attachment to the bicycle via the device is in front of the turning axis of the bicycle.

Other aspects and preferred aspects are disclosed in the specification, comprising the accompanying drawing, and/or defined in the appended claims, which all form a part of the description of the invention.

In essence, the present invention stems from the realisation that providing an angled portion in a pet restraint for attachment to a vehicle such that the angled portion extends away from the line of the front of the vehicle allows for greater safety and control of both the pet and the vehicle.

The present invention has been found to result in a number of advantages, such as not only allowing the dog to pull the bike rider along (if desired), but it also allows a person to ride beside their dog, at the dog's speed, while keeping the riders hands free to steer, change gears, operate the handbrakes, etc.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF DRAWINGS

Further disclosure, improvements, advantages, features and aspects of the present invention may be better understood by those skilled in the relevant art by reference to the following description of preferred embodiments taken in conjunction with the accompanying drawings, which are given by way of illustration only, and thus are not limiting to the scope of the present invention, and in which:

FIG. 1 is a schematic diagram of an example embodiment of the present invention;

FIG. 2 illustrates, in side and front view, the attachment positions of the pet restraint of an embodiment of the present invention to a bicycle;

FIG. 3 shows a lead attachment for use with a pet restraint in accordance with an embodiment of the present invention;

FIG. 4 illustrates the use of the pet restraint in accordance with an example embodiment of the present invention.

FIG. 5 illustrates a comparison between an angled pet restraint in accordance with an example embodiment of the present invention and a straight connection for a pet restraint in accordance with a variation of the present invention;

FIG. 6 illustrates a schematic layout of components of the pet restraint of an embodiment of the present invention;

FIG. 7 illustrates a bicycle in accordance with an example embodiment mounted on a bicycle rack;

FIG. 8 shows an alternative embodiment to that shown in FIG. 7.

### DETAILED DESCRIPTION

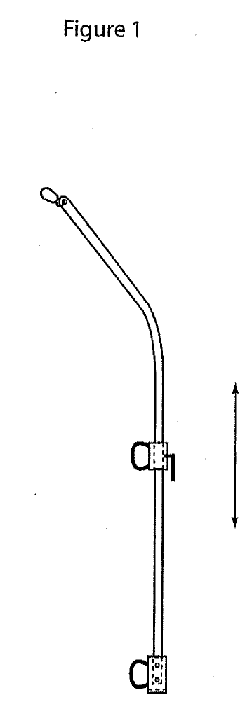

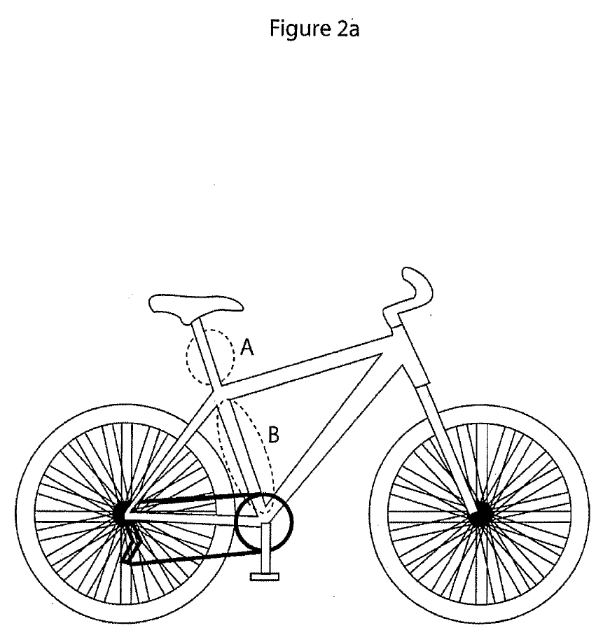

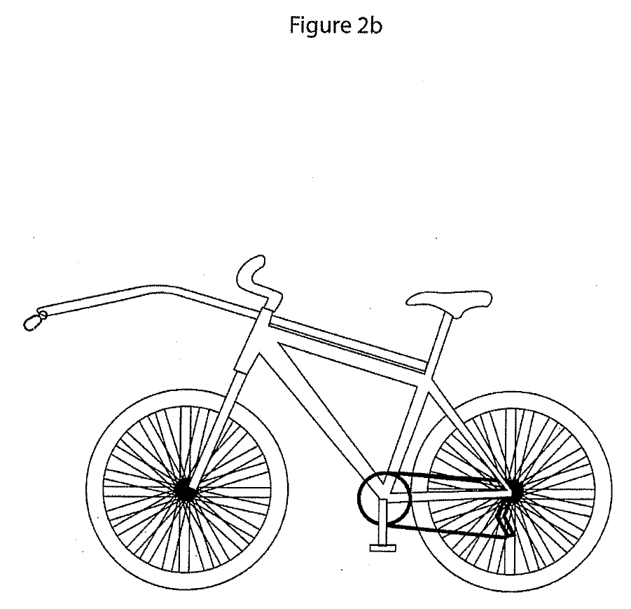

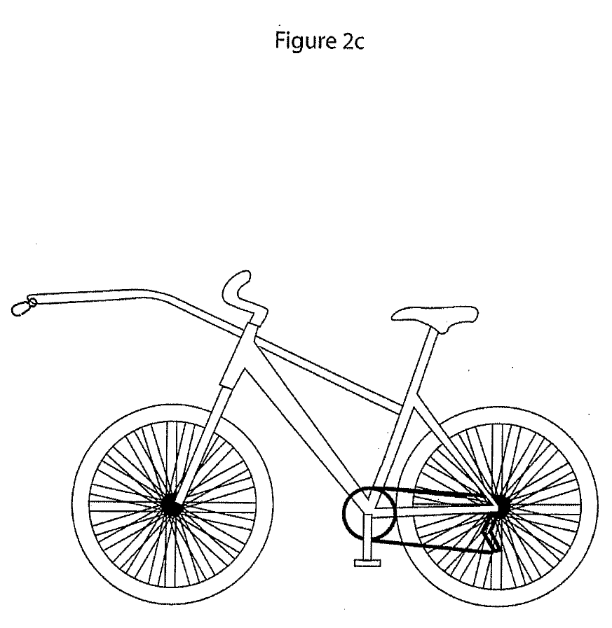

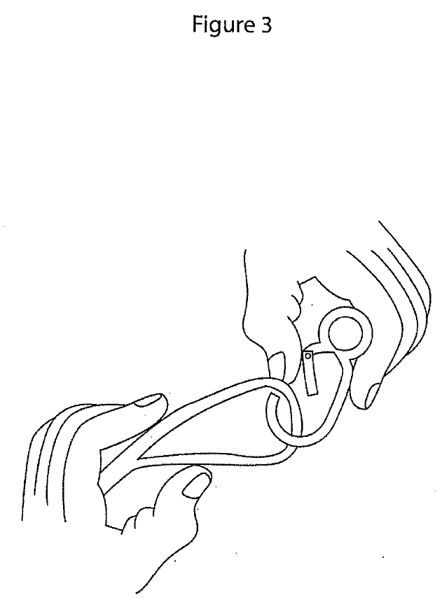

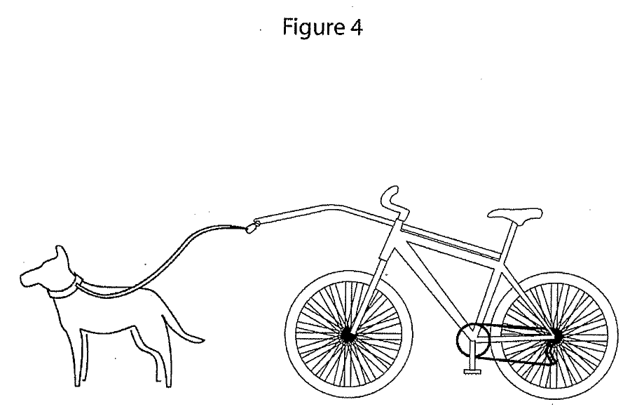

The pet restraint of the present invention attaches to a vehicle such as a bike by way of at least one fastening means. In an example embodiment the attachment to a vehicle is, via one fixed bracket and one adjustable bracket as shown in FIG. 1.

The fixed bracket attaches to either the seat pole or the section of the bike frame that the seat pole slots into. The adjustable bracket attaches to the front of the bike frame. This bracket may be adjustable to accommodate bicycles, which come in different shapes and sizes.

A lead attachment attaches the restraint to a dog's lead. The lead is attached to the dog via a harness as shown in FIG. 3.

The rider of the vehicle is given freedom to have full functionality of the bike's steering, gears and hand brakes; as the rider does not have to hold onto the dogs lead. As in the related art, if the dog lead is held by hand, this will increase the risk of an accident, as a dog can pull up faster and take off faster than a rider. Like a sled, the restraint of the present invention can also be used by the dog to pull the bike along. This is great for working breeds that require a lot of exercise. The design of the present invention prevents the dog from running off, as he/she is secure on a lead. The present invention's unique angular shape has a number of functions, these include the following.

Keeps the dog lead away from the front wheel or other movable parts of the bike (vehicle), thus preventing any damage or harm to property, animal or person.

Keeps the dog to the bike rider's left, so that the dog is not in the rider's path, and therefore limits the chances of the dog being hit by the bike. It is to be noted that a dog can stop quicker than a bike rider.

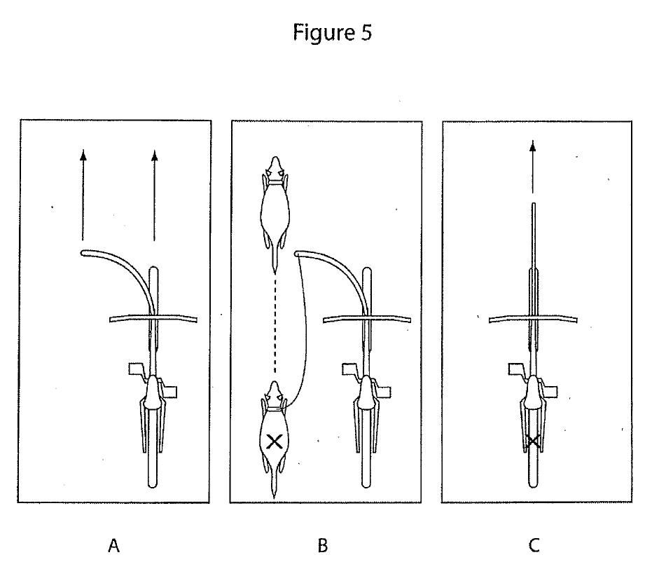

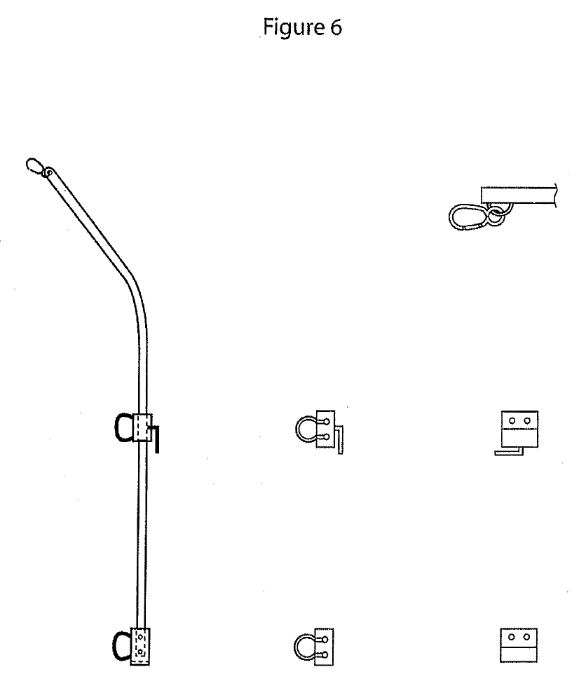

If the restraint was a straight design, and the dog suddenly stopped, even if the rider is able to swerve around the dog, the final position of the dog will be in line with the lead attachment part of the restraint. Therefore the dog will end up hitting the bike as illustrated in FIG. 5c. The restraint keeps the dog away from oncoming traffic. As the bike rider will be in between the dog and oncoming traffic.

Referring to FIG. 5a, when the dog suddenly pulls at a right angle to the bicycle, the rider has an advantageous ability to steer into the direction that the dog is pulling, as the dogs attachment to the bicycle is in front of the turning axis of the bicycle.

By having the second portion angled away from the line of the vehicle greater safety and control of both the pet and the vehicle is provided. Furthermore, having the lead attachment well out in front of the bicycle means that the dog and its lead are in the rider's normal viewing area. This is in comparison to having the lead attachment at the center of the bicycle which will mean that the dog is out of the rider's general viewing area in most instances. With the present arrangement the dog is encouraged to be spaced towards the front of the vehicle, so as to be visible, and be spaced laterally from the vehicle so as to limit accidental contact therewith.

Being able to see what the dog is doing provides more time to react in avoiding dangerous obstacles such as trees and poles. It also allows a person to discipline his or her dog when the dog begins or looks like it will begin to misbehave. Being able to see the lead at all times also helps with preventing the lead from contacting the ground and being entangled in the wheels of the bicycle and so on.

The restraint allows even body tone in exercising a pet as the position of the lead attachment is in line with the centre of the dog's back when the dog is pulling the bike, and not to the dog's side. The restraint helps keep the dog to the left of the bike, so that the dog can run on the soft grass while the owner rides on the bike track (bitumen/concrete). Generally a dog prefers to sprint on soft surfaces. The restraint controls the dog's running direction. If the dog was directly in front like it is with a sled, the dog can run off to the left or right as it chooses (if you don't take into consideration the reins). With the present restraint the direction of the bike controls the direction of the dog. The dog can't run to the right because the bike is there, and it can only run to the left as far as the lead allows. Basically, the dog will be pulled in the direction of the bike if it tries to run off course.

The restraint can also be turned over to keep the dog on the right hand side of the rider, for countries like the USA where they ride/drive on the right hand side.

There may be modifications made to the bracket attachments, which will not affect functionality and, which would be recognised by the person skilled in the art. These attachments may be made from plastic, steel or other materials and the shape of these brackets may vary as would be recognised by the person skilled in the art.

In comparison to other arrangements, the angled portion extends away from the line of the vehicle to allow for greater safety and control of both the pet and the vehicle. In situations when standing on the pedals of the bicycle, when riding up a steep incline, the device does not limit the rider's leg movement and therefore avoids injury. This is achieved by the device being of a relatively narrow configuration such that a person's knees can easily move past the device. In this embodiment the device is 25 mm wide so that a person's knees easily move past the device. The device is designed to allow the rider to maintain sufficient functionality of the bicycle while having a relatively small impact on the rider's position and control.

The fastening means provide a mechanism that can be considered under local law as being a sufficient restraint for a dangerous dog. Furthermore, the arrangement is detachable and is not a permanent part of the bicycle. It is designed to be detachable to bicycles of varying shape and size and does not require any tools to connect it to the bicycle as it uses hand tightened wing nuts.

As discussed, the device allows substantially even body tone in exercising pet as the position of the lead attachment is substantially in line with the centre of the dogs back when the dog is pulling the bike, and not merely to the dog's side. Devices that attach to low lying sections of the bike will cause the dog to pull from its side, if the dog's shoulders are higher then the lead attachment. With a low lying device the dog also runs the risk of being hit by the device if the dog suddenly stops while running directly in front of the device and the bicycle. If the dog is running directly behind the device and the bicycle suddenly stops, the dog runs the risk of running into the device.

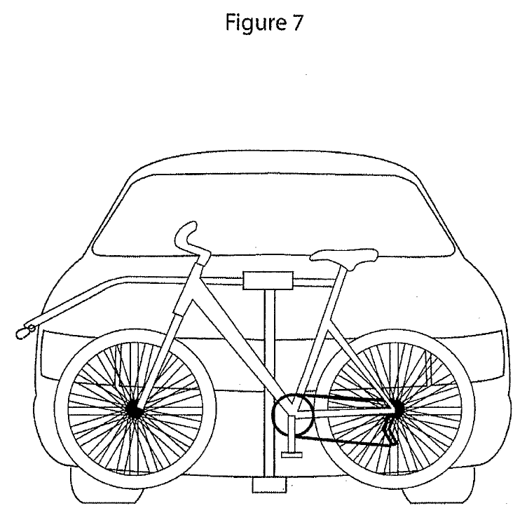

When attached to a woman's bicycle the device allows easier mounting of the bicycle to a car bicycle rack as shown in FIG. 7. Thus the bicycle does not need to be lifted as high to mount on the rack, making it easier for people who aren't strong enough to lift a bicycle high up off the ground, such as the elderly. Less lifting and effort is required.

The device is accordingly adapted to the bicycle such that the bicycle sits horizontally on the rack, rather diagonally via the bicycle's diagonal center bars. This results in the bicycle being more balanced on the rack, that is, less likely to rotate or slip than when mounted diagonally. In arrangements this allows both hands free while placing another bicycle on the rack and while doing up the rack's clamp.

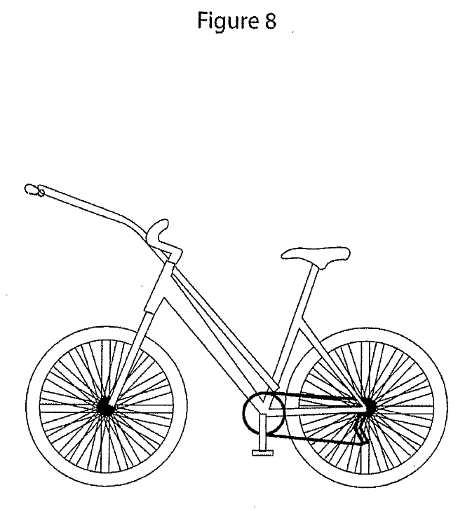

The location of the second portion is advantageous for mounting on a rack in comparison to other protruding devices. If the second portion were to protrude at pedal level on the side of the bicycle which faces the car, once placed on the rack, it would have a high risk of hitting the car. If the protrusion were to face away from the car at pedal level then this would make it harder for another bicycle to be placed on the rack. The second portion advantageously protrudes out in front and to the side, rather than at right angles allowing for multiple bicycles can be placed on the rack. In alternative arrangements the device more closely conforms to the construction of a female bike. One such arrangement is shown in FIG. 8.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.

1. A pet restraint for restraining a pet to a vehicle comprising:
an elongated member comprising:
a first portion proximate the vehicle for mounting the elongated member to the vehicle wherein said first portion comprises at least one fastening means adapted to engage the vehicle;
a second portion distal of the vehicle for engaging a pet wherein said second portion extends away from the vehicle.

2. A pet restraint as claimed in claim 1 wherein the second portion extends away from the front of the vehicle in a direction so as to be laterally spaced therefrom.

3. A pet restraint as claimed in claim 1 wherein the second portion extends away from the front of the vehicle in a manner whereby the second portion is laterally spaced therefrom and is longitudinally in front thereof.

4. A pet restraint as claimed in claim 1 wherein the second portion extends away from the front of the vehicle in a manner whereby the second portion is laterally spaced therefrom and is substantially longitudinally in line therewith.

5. A pet restraint as claimed in claim 1 wherein the at least one fastening means comprises at least one of:
a fixed fastening means and;
an adjustable fastening means.

6. A pet restraint as claimed in claim 5 wherein the adjustable fastening means and the fixed fastening means, in combination, provide for mounting the elongated member to vehicles of varying shape and size.

7. A pet restraint as claimed in claim 1 wherein the vehicle comprises one of:
a bicycle;
a sled; or
a scooter.

8. A pet restraint as claimed in claim 1 wherein the second portion comprises a lead attachment for attaching the second portion to a pet lead.

9. A pet restraint as claimed in claim 8 wherein the pet lead comprises a dog lead.

10. A pet restraint for a vehicle, the restraint comprising: a elongate member providing a first portion and a second portion; the first portion including at least one fastening means adapted to engage the vehicle such that when the first portion is mounted to the vehicle, the second portion extends in a forward direction, relative to the vehicle, and laterally away from the vehicle in a manner such that when a pet is restrained from the second portion the pet will be encouraged to be spaced towards the of the front vehicle, so as to be visible, and be spaced laterally from the vehicle so as to limit accidental contact therewith.

11. A pet restraint as claimed in claim 10 wherein the second portion comprises a length of the elongate member angled away from the remainder of the elongate member, the remainder comprising the first portion and the second portion being angle so that the second portion will extend laterally away from the vehicle.

12. A pet restraint as claimed in claim 10 wherein the at least one fastening means comprises a first fastener and a second fastener spaced apart so that the first portion extends along the length of the vehicle when engaged therewith.

13. A pet restraint as claimed in claim 12 wherein the second portion is disposed at a height similar to the height of the vehicle.

14. A pet restraint as claimed in claim 12 wherein the first portion comprises a rod along which the first fastener is moveable such that the first portion is engageable with vehicles of different size.

15. A pet restraint as claimed in claim 10 wherein the second portion comprises a lead attachment for attaching the second portion to a pet lead.

16. (canceled)
